(19) United States
(12) Patent Application Publication
(10) Pub. No.: US 2022/0410752 A1
(43) Pub. Date: Dec. 29, 2022

(54) ADAPTER FOR ELECTRIC VEHICLE SUPPLY EQUIPMENT (EVSE)

(71) Applicant: Jon E. Plasterer, II, Beaver Springs, PA (US)

(72) Inventor: Jon E. Plasterer, II, Beaver Springs, PA (US)

(21) Appl. No.: 17/361,812

(22) Filed: Jun. 29, 2021

(51) Int. Cl. B60L 53/66; B60L 53/16; H01R 31/06; H01R 13/52; H01R 13/631

(52) U.S. Cl. CPC B60L 53/66; B60L 53/16; H01R 31/065; H01R 13/5213; H01R 13/631; H01R 2201/26

(57) ABSTRACT

The present disclosure relates generally to an electrical adapter and, more particularly, to an adapter for electric vehicle charging system s. The adapter includes: a housing; a male connector at a first side of the housing which is structured to plug into an electric device; a female connector at a second side of the housing which is structured to plug into a charging system; and a controller which provides management functions to provide an electric charge to the electric device.

### TECHNICAL FIELD

The present disclosure relates generally to an electrical adapter and, more particularly, to an adapter for electric vehicle supply equipment (EVSE).

### BACKGROUND

Gas stations are an essential infrastructure for the current transportation system. However, with the push towards green technologies including electric vehicles, the infrastructure needs to be expanded to include electric charging stations. The expansion of the electric infrastructure will provide the necessary impetus and confidence for the widespread use of electric vehicles, which automakers have pledged to greatly expand manufacture of such vehicles in coming years.

Compared to gas pumps, though, electric charging stations are very expensive to install with less profit compared to conventional gas pumps. Also, in addition to the cost of to install charging stations, the technology has not completely evolved such that retailers who install charging stations risk owning antiquated technology. This makes early adapters of the technology even more hesitant to risk their investment by installing charging stations. With this noted, it becomes ever more difficult to build out the necessary infrastructure and, with limited range of electric vehicles, it makes drivers reluctant to invest in electric vehicles.

### SUMMARY

In a first aspect of the present disclosure, an adapter comprises: a housing; a male connector at a first side of the housing which is structured to plug into an electric device; a female connector at a second side of the housing which is structured to plug into a charging system; and a controller which provides management functions to provide an electric charge to the electric device.

In another aspect of the present disclosure, an adapter comprises: a housing comprising a male connector and a female connector; a controller which manages electric flow between the male connector and the female connector; and a communication device that communicates information between the controller and at least one remote device.

In a further aspect of the present disclosure, a system comprises: a processor, a computer readable memory, one or more computer readable storage media, and program instructions collectively stored on the one or more computer readable storage media, the program instructions executable to: detect an electric vehicle is plugged into an electric vehicle supply system; provide an electric charge to the electric vehicle through the electric vehicle supply system when the electric vehicle is detected to be plugged into the electric vehicle supply system; monitor and manage the electric charge to the electric vehicle; and provide information associated with the electric charging of the electric vehicle to an owner of the electric vehicle supply system and a driver of the electric vehicle via wireless communication.

### BRIEF DESCRIPTION OF THE DRAWINGS

Aspects of the present disclosure are described in the detailed description which follows, in reference to the noted plurality of drawings by way of non-limiting examples of exemplary embodiments of the present disclosure.

FIG. 1 shows a perspective view of an adapter for electric vehicle supply equipment (EVSE) in accordance with aspects of the present disclosure.

FIG. 2 shows the adapter connected to an EVSE in accordance with aspects of the present disclosure.

FIG. 3 shows the adapter connected to a plug mounted inside a garage or other appropriate, interior space in accordance with aspects of the present disclosure.

FIGS. 4A and 4B show different connection types for either a female connector or male connector of the adapter in accordance with aspects of the present disclosure.

FIG. 5 is an illustrative architecture of a computing system implemented in embodiments of the present disclosure.

FIG. 6 shows an exemplary cloud computing environment in accordance with aspects of the present disclosure.

FIG. 7 shows an exemplary user interface of a mobile application residing on a mobile device platform in accordance with aspects of the present disclosure.

### DETAILED DESCRIPTION OF ASPECTS OF THE INVENTION

The present disclosure relates generally to an electrical adapter and, more particularly, to an adapter for electric vehicle supply equipment (EVSE). More specifically, in embodiments, the adapter for the electric vehicle supply equipment (EVSE) (hereinafter referred to as “electric vehicle charging system” or “charging system”) is a comprehensive system which includes both a hardware component and a software component(s) (e.g., controller) that allows electric vehicle (EV) owners to offer use (i.e., in the form of a short term lease) of their personal charging systems to other users of electric vehicles or other devices suitable for connection to such charging systems. For example, the hardware component comprises, amongst other systems, a metered connection adapter which can be connected to both a legacy personal charging system and an electric vehicle; whereas, the software component can be a controller that provides management services such as, e.g., communications, metering, and monitoring of the charging system.

Advantageously, the adapter described herein provides benefits to drivers of electric vehicles (EV) by increasing the availability of charging locations and, hence, providing an alternative to the national charging networks, e.g., Tesla Superchargers, Electrify America, etc. Moreover, the adapter provides benefits to the environment by encouraging green energy producers with excess energy to market to EV drivers, while also having the potential to quickly reduce range anxiety among potential EV buyers as charging locations will increase with every available adapter. The adapters also benefit the owners of personal charging systems as they will often be able to offset their costs of such system by leasing their charging system at a rate that may be higher than the current rate they pay for electricity.

### Hardware Infrastructure

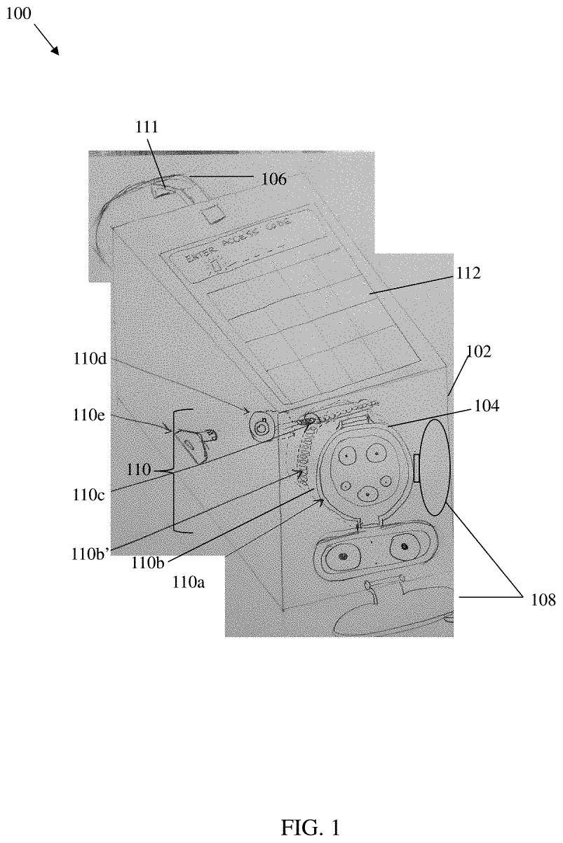

FIG. 1 shows a perspective view of an adapter for electric vehicle charging system in accordance with aspects of the present disclosure. In embodiments, the adapter 100 includes a housing 102. The housing 102 can be composed of any appropriate materials such as, e.g., plastic, metal, metal alloys, etc. In embodiments, housing 102 is composed of weatherproof materials that can withstand different environmental conditions. The housing 102 will house hardware components and software components (e.g., a controller) as described in further detail herein.

Still referring to FIG. 1, a female electrical connector 104 extends from a first side of housing 102 and a male connector (e.g., plug) 106 extends from a second side of housing 102. The female electrical connector 104 and male connector 106 are electrically coupled to one another within housing 102 in order to provide electric charging capabilities between a charging system and an electric vehicle.

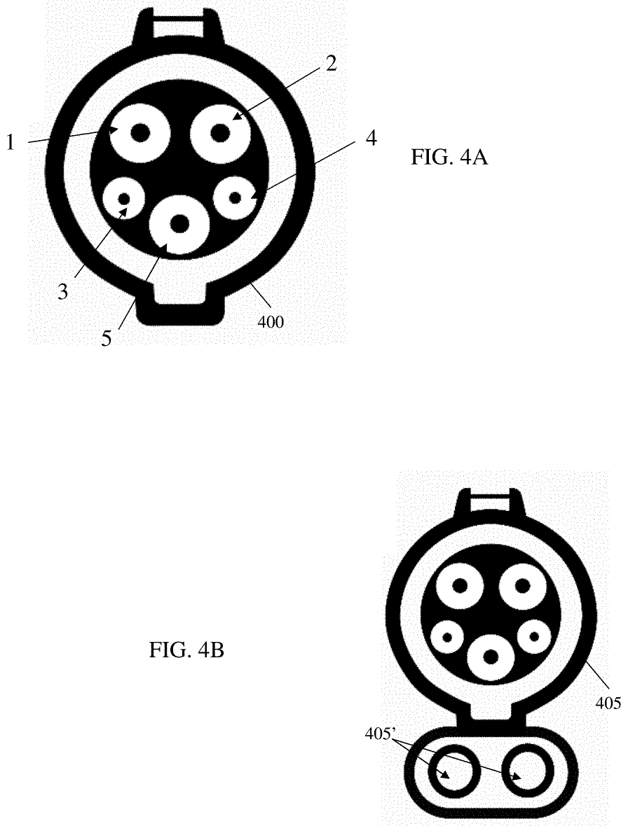

In embodiments, female electrical connector 104 is designed, configured and structured to connect to an existing electrical connector of a charging system such as, e.g., Electric Vehicle Supply Equipment (EVSE); whereas, male connector 106 is designed, configured and structured to plug into different electric vehicles. The male connector 104 can include any type of male connector (e.g., plug) that is compatible with existing electric vehicles. For example, both female connector 104 and male connector 106 can include various connection types such as a J1772-2009 connection type shown in FIG. 4A or a CCS Type 1 connection type shown in FIG. 4B; although it should be understood that adapter 100 is compatible with multiple types of charging systems and those shown in FIGS. 4A and 4B should not be considered a limiting feature of the present disclosure. In embodiments, female electrical connector 104 in combination with male connector 106 can provide the same safety features of the EVSE system as described in detail herein.

As should be understood by those of skill in the art, EVSE supplies electric energy to charge plug-in electric vehicles. The EVSE includes a protocol to keep the user and electric vehicle safe while charging. By using the same pin/plug configuration for female electrical connector 104 and male connector 106, these same protocols will be provided by adapter 100. For example, using two-way communication between the charging system and electric vehicle (which now flows through adapter 100), the correct charging current is set based on the maximum current the charging system can provide as well as the maximum current the electric vehicle can receive. As part of the protocol, a safety lock-out exists, preventing current from flowing when the charging system is not connected to the electric vehicle. In this way, adapter 100 ensures that if a cable is not correctly inserted, power will not flow through it. The adapter 100 can also detect hardware faults, disconnecting the power and preventing battery damage, electrical shorts or fire. The manner in which these safety features are provided are described in more detail with respect to FIGS. 4A and 4B.

Again referring to FIG. 1, a flexible locking tab 111 extends from housing 102 adjacent to male connector 106. In embodiments, flexible locking tab 111 can engage with the electric vehicle to ensure that adapter 100 maintains its proper position on the vehicle during charging operations. Also, female electrical connector 104 may include a cover 108. In embodiments, cover 108 can be a spring loaded, hinge mounted dust cover. The cover 108 can be a single cover or multiple covers depending on the configuration of female electrical connector 104. As shown in FIG. 1, for example, two covers 108 may be used to cover female electrical connector 104 of a CCS Type 1 connector configuration.

FIG. 1 further shows a locking mechanism at reference numeral 110. In embodiments, locking mechanism 110 prevents a user from disconnecting adapter 100 from a charging system, preventing theft or tampering of adapter 100. More specifically, locking mechanism 110 includes a female socket inner wall squeeze pad 110a which is designed, structured and configured to accommodate both a J1772-2009 connection type and a CCS Type 1 connection type; although other configurations are also contemplated herein. By way of more specific example, female socket inner wall squeeze pad 110a comprises a perimeter wall that is designed, structured and configured to lock different plugs, e.g., J1772-2009 connection, to female electrical connector 104 using a friction connection. For example, socket inner wall squeeze pad 110a can be composed of a flexible material, e.g., polyurethane, which is capable of squeezing connection type (plug) to adapter 100 by use of a restricting band 110b, thereby locking it in place.

In embodiments, restricting band 110b can be a stainless steel band that is housed within housing 102 such that it is not accessible from outside of housing 102. As shown, restricting band 110b surrounds socket inner wall squeeze pad 110a and includes a plurality of slots 110b′ which are engaged by a screw drive 110c. In operation, restricting band 110b can be tightened by rotating screw drive 110c in a clockwise direction through a cylinder hole 110d extending within housing 102. As should be understood by those of ordinary skill in the art, screw drive 110c will engage with slots 110b′ and, as screw drive 110c rotates, the circumference of restricting band 110b will become smaller, thereby locking female socket inner wall squeeze pad 110a to the connection type (e.g., plug) by a friction fit connection. A cylinder lock 110e can be used to lock restricting band 110b, e.g., prevent access to or rotation of screw drive 110c.

FIG. 1 further shows a user interface 112. In embodiments, user interface 112 includes a keypad and display screen. The user interface 112 allows a user to communicate with adapter 100 by, for example, entering an access code (e.g., UserID or PIN code) to activate the charging portion of adapter 100. The user interface 112 can also provide messages to the users, in addition provide access to the software modules (e.g., controller) of adapter 100. As described in further detail below, the controller can include a communication module, metering system or security features, as non-limiting illustrative examples.

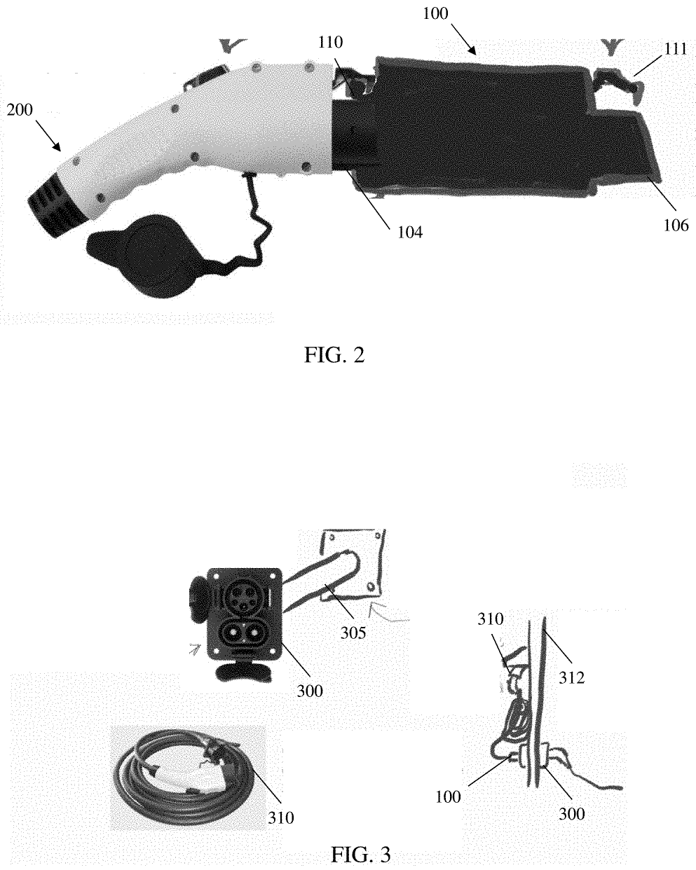

FIG. 2 shows adapter 100 connected to a charging system 200. In embodiments, charging system 200 will be locked to female electrical connector 104 by use of locking system 110. In this way, a user cannot disconnect charging system 200 from female electrical connector 104. It should also be understood that in further embodiments, the adapter may be part of the charging system (e.g., EVSE), itself. That is, the charging system can be manufactured with the adapter or equivalent functionality and capability as described herein. In this way, the charging system (e.g., EVSE) can have a user interface built directly into it in order to provide the features as described herein.

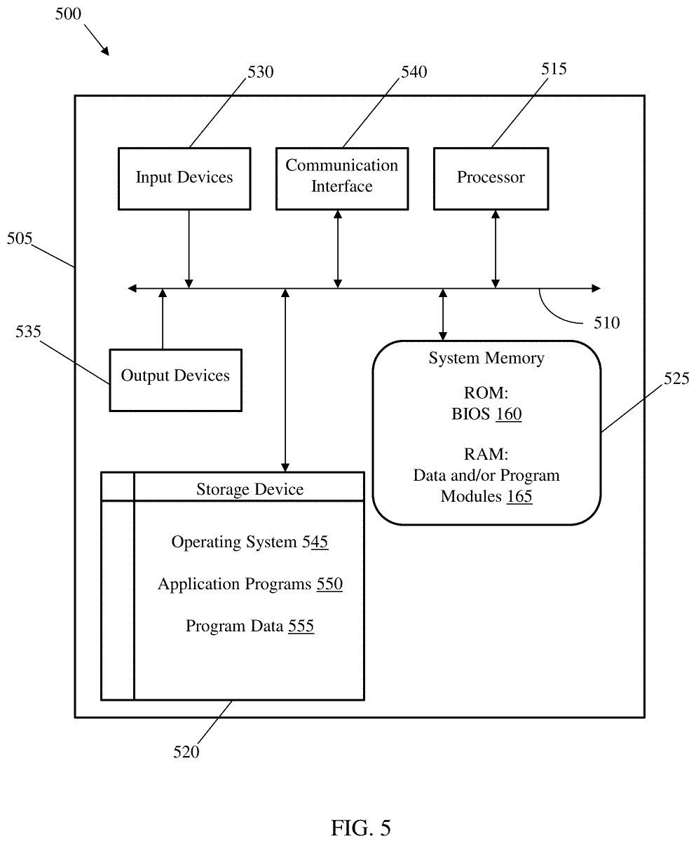

FIG. 3 shows an adapter 100 connected to a plug 300 mounted inside a garage or other appropriate, interior space. The plug 300 can be a weatherproof plug which will receive a legacy plug of a charging system. The plug 300 can be connected to adapter 100 through use of a conduit 305, with adapter 100 mounted to an outside wall 312 of interior space. The conduit 305 can be adjustable depending on the thickness of wall 312. An off the shelf connector 310 can be connected or plugged into adapter 100. In alternative embodiments, adapter 100 can mounted in an interior space with plug 300 connected to the outside via an outlet. In this alternative embodiment, adapter 100 can be remotely controlled through a communication module as described with respect to FIG. 5. In this way, the public will have no contact with either the charging system or adapter 100.

FIGS. 4A and 4B show different connection types for either female connector 104 or male connector 106. For example, FIG. 4A shows a J1772-2009 connection type 400 and FIG. 4B shows a CCS Type 1 connection type 405. Note that both J1772-2009 connection type 400 and CCS Type 1 connection type 405 are designed for single phase electrical systems with 120V or 240V, with a round diameter connector comprising five pins (or female receptacles) with different sizes. For example, pin 1 is an AC Line 1, pin 2 is a AC Neutral (120V Level 1) or AC Line 2 (208 to 240V Level 2), pin 3 is a Proximity Pilot pin (PP), also known as “plug present”, pin 4 is a Control Pilot pin (CP) and pin 5 is a ground pin. In connection type 405, pins 405′ (or female receptacles) are direct current (DC) pins.

In embodiments, the Proximity Pilot pin provides proximity detection which may comprise a signal to the vehicle's control system so it can prevent movement while connected to the electric vehicle supply equipment (e.g., the charging station), and signals a latch release button to the vehicle. The Control pilot provides a communication line used to signal a charging level between the vehicle and the charging system. For example, a 1 kHz square wave at ±12 volts generated by the charging system, e.g., EVSE, on the control pilot line can detect the presence of the vehicle, communicate the maximum allowable charging current, and control charging begin/end times. The charging can be four levels of charging: AC Level 1, AC Level 2, DC Level 1, and DC Level 2.

As with the J1772 standard, adapter 100 also includes several levels of shock protection, ensuring the safety of charging even in wet conditions. For example, physically, the connection pins are isolated on the interior of the connector when mated, ensuring no physical access to those pins. When not mated, connectors have no power voltages at the pins, and charging power does not flow until commanded by the vehicle. The ground pin is of the first-make, last-break variety. If the plug is in the charging port of the vehicle and charging, and it is removed, the shorter control pilot pin will break first causing the power relay in the charging system to open, stopping current flow to adapter 100. The proximity detection pin is also connected to a switch that is triggered upon pressing the physical disconnect button when removing the connector from the vehicle. This causes the resistance to change on the proximity pin which commands the vehicle's onboard charger to stop drawing current immediately. The vehicle can then release the control pilot which will cause the power relay to release.

### Computing Infrastructure and Controller

In embodiments, adapter 100 also includes certain control functions which may be implemented as a controller in a computing infrastructure. In embodiments, the controller manages electric flow within the adapter, e.g., between the male connector and the female connector, to an electric vehicle. Implementations of the present disclosure may be a system, a method, and/or a computer program product (e.g., software modules or controller). The computer program product may include a computer readable storage medium (or media) having computer readable program instructions thereon for causing a processor to carry out aspects of the present disclosure.

More specifically, FIG. 5 is an illustrative architecture of a computing system 500 implemented in embodiments of the present disclosure. The computing system 500 is only one example of a suitable computing system for implementing the controller functionality, and is not intended to suggest any limitation as to the scope of use or functionality of the disclosure. Also, computing system 500 should not be interpreted as having any dependency or requirement relating to any one or combination of components illustrated in computing system 500.

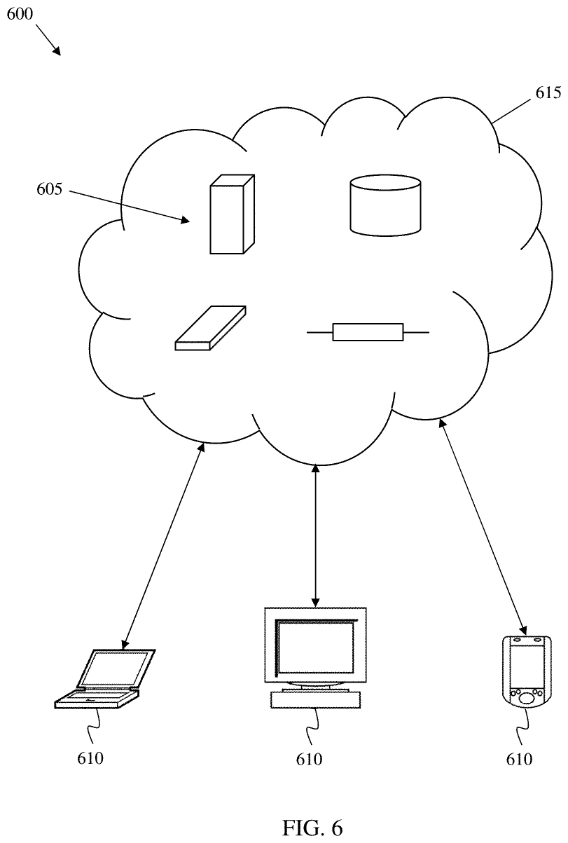

As shown in FIG. 5, computing system 500 includes a computing device 505. The computing device 505 can be a separate independent computing device resident in housing 102 of adapter 100 and implemented in a network infrastructure such as within a cloud environment as shown in FIG. 6. The computing device 505 may include a bus 510, a processor 555, a storage device 520, a system memory (hardware device) 525, one or more input devices 530, one or more output devices 535, and a communication interface 540.

The bus 510 permits communication among the components of computing device 505. For example, bus 510 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 505.

The processor 555 may be one or more processors or microprocessors that include any processing circuitry operative to interpret and execute computer readable program instructions, such as program instructions for controlling the operation and performance of one or more of the various other components of computing device 505. In embodiments, processor 555 interprets and executes the processes, steps, functions, and/or operations of the present disclosure, which may be operatively implemented by the computer readable program instructions. For example, processor 555 enables computing device 505 to provide control functions of adapter 100 including, e.g., communication, security, messaging, metering of electricity, monitoring, management (including financial transactions) and other operability and safety features as described herein.

In embodiments, processor 555 may receive input signals from one or more input devices 530 and/or drive output signals through one or more output devices 535. The input devices 530 may be, for example, user interface 112 of adapter 100 or a remote source (e.g., computing device of the owner of the charging system or a driver of an electric vehicle) through a communication protocol as is known to those of skill in the art such that no further description is required for a complete understanding of the present disclosure. The output devices 535 can be, for example, any display device, e.g., screen of user interface 112, as is known to those of skill in the art such that no further description is required for a complete understanding of the present disclosure.

The storage device 520 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 505 in accordance with the different aspects of the present disclosure. In embodiments, storage device 520 may store operating system 545, application programs 550, and program data 555 in accordance with aspects of the present disclosure.

The system memory 525 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 560 (BIOS) including the basic routines that help to transfer information between the various other components of computing device 505, such as during start-up, may be stored in the ROM. Additionally, data and/or program modules 565, such as at least a portion of operating system 545, application programs 550, and/or program data 555, that are accessible to and/or presently being operated on by processor 555 may be contained in the RAM.

The communication interface 540 may include any transceiver-like mechanism (e.g., a network interface, a network adapter, a modem, or combinations thereof) that enables computing device 505 to communicate with remote devices or systems. The remote devices or systems may be within a networked environment, e.g., cloud environment. These remote devices or systems may be a computing device of the owner of the charging system or a driver of the electric vehicle itself. For example, computing device 505 may be connected to remote devices or systems via one or more local area networks (LAN), one or more wide area networks (WAN), WiFi or Bluetooth enabled technologies using communication interface 540.

In more specific embodiments, communication interface 540 allows both the owner of the charging system and driver of an electric vehicle to communicate with adapter 100, as well as providing Internet capabilities to adapter 100. For example, communication interface 540 can provide the location information of the charging system to the driver of the electric vehicle, in addition to providing the ability to make reservations for the charging system. In another example, communication interface 540 allows adapter 100 to automatically communicate directly with the electric vehicle upon connection to the adapter 100 (by detection of the proximity pin as an example) including, for example, providing a proper access code (e.g., UserID or PIN code) via a handshake protocol to authorize use of the charging system. In embodiments, the proper access code (e.g., UserID or PIN code) can be provided to the driver of the electric vehicle upon making a reservation. Also, in embodiments, the driver can enter the access code, ID or other required information manually using user interface 112 or remotely by use of a WiFi or Bluetooth enabled mobile device, with or without a reservation.

In addition, communication interface 540 allows the owner of the charging system to provide user messages or status of the charging system (e.g., available, off-line, in use, estimated time available to full charge, last connection time, error messages, etc.), compatibility and charge infrastructure, charge rates and pricing, power source (e.g., renewable type, grid, etc.) and other information that the user (e.g., driver of the electric vehicle) could filter and sort by to select appropriate charging locations, amongst other information. Moreover, communication interface 540 permits other monitoring, metering and financial transactions.

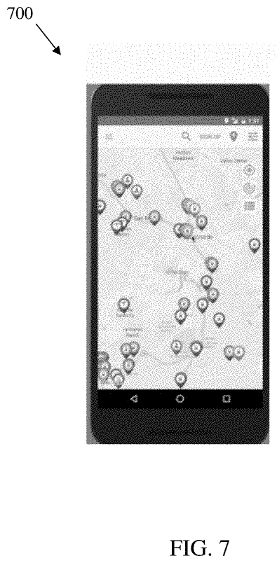

The computing device 505 may also perform other tasks (e.g., process, steps, methods and/or functionality) in response to processor 555 executing program instructions contained in a computer readable medium, such as system memory 525. These tasks include, for example, managing meter and payment data from adapter 100 and conduct the financial transaction based on the reservations made, electricity transferred and other specifics of the transaction. Payment would be via linked credit card, bank account or third party pay system (e.g., PayPal, FordPass, etc.). The computing device 505 can also provide metering capabilities, e.g., meter the start and stop of current flow, and a monitoring capability that would determine the status and security of the charge port. For example, the monitoring capability would prevent theft or unauthorized access of the charging system. In addition, computing device 505 can provide a management system that would coordinate the above functions. The computing device 505 can also provide other features as noted, for example, with respect to functionality/capability described with respect to FIG. 7.

The program instructions may be read into system memory 525 from another computer readable medium, such as data storage device 520, or from another device via the communication interface 540 or server within or outside of a cloud environment. In embodiments, an operator may interact with computing device 505 via the one or more input devices 530 and/or the one or more output devices 535 to facilitate performance of the tasks and/or realize the end results of such tasks in accordance with aspects of the present disclosure. In additional or alternative embodiments, hardwired circuitry may be used in place of or in combination with the program instructions to implement the tasks, e.g., steps, methods and/or functionality, consistent with the different aspects of the present disclosure. Thus, the steps, methods and/or functionality disclosed herein can be implemented in any combination of hardware circuitry and software.

FIG. 6 shows an exemplary cloud computing environment 600 in accordance with aspects of the disclosure. Cloud computing is a computing model that enables convenient, on-demand network access to a shared pool of configurable computing resources, e.g., networks, servers, processing, storage, applications, and services, that can be provisioned and released rapidly, dynamically, and with minimal management efforts and/or interaction with the service provider. In embodiments, one or more aspects, functions and/or processes described herein may be performed and/or provided via cloud computing environment 600.

As depicted in FIG. 6, cloud computing environment 606 includes cloud resources 605 that are made available to client devices 610 (e.g., owners of the charging system and potential users of the charging system) via a network 615, such as the Internet. Cloud resources 605 can include a variety of hardware and/or software computing resources, such as servers, databases, storage, networks, applications, and platforms. Cloud resources 605 may be on a single network or a distributed network. Cloud resources 605 may be distributed across multiple cloud computing systems and/or individual network enabled computing devices. Client devices 610 may comprise any suitable type of network-enabled computing device including adapter 100 and desktop computers, laptop computers, handheld computers (e.g., smartphones, tablet computers) of both the owner of the charging system and the drivers of electric vehicles. Cloud resources 605 may allow access to any of client devices 610, and are typically provided and maintained by a service provider so that a client does not need to maintain resources on a local client device 610, e.g., adapter or other device of the owner of the charging system. In embodiments, cloud resources 605 may include one or more computing system that is specifically adapted to perform one or more of the functions and/or processes described herein.

Cloud computing environment 600 may be configured such that cloud resources 605 provide computing resources to client devices 610 through a variety of service models, such as Software as a Service (SaaS), Platforms as a service (PaaS), Infrastructure as a Service (IaaS), and/or any other cloud service models. Cloud resources 605 may be configured, in some cases, to provide multiple service models to a client device 610. For example, cloud resources 605 can provide both SaaS and IaaS to a client device 610. Cloud resources 605 may be configured, in some cases, to provide different service models to different client devices 610. For example, cloud resources 605 can provide SaaS to a first client device 610 and PaaS to a second client device 610.

In embodiments, software and/or hardware that performs one or more of the aspects, functions and/or processes described herein may be accessed and/or utilized by a client (e.g., an enterprise or an end user) as one or more of an SaaS, PaaS and IaaS model in one or more of a private, community, public, and hybrid cloud. Moreover, although this disclosure includes a description of cloud computing, the systems and methods described herein are not limited to cloud computing and instead can be implemented on any suitable computing environment.

Cloud computing environment 600 may be configured such that cloud resources 605 provide computing resources to client devices 610 through a variety of deployment models, such as public, private, community, hybrid, and/or any other cloud deployment model. Cloud resources 605 may be configured, in some cases, to support multiple deployment models. For example, cloud resources 605 can provide one set of computing resources through a public deployment model and another set of computing resources through a private deployment model.

Cloud resources 605 may be configured to provide a variety of functionality that involves user interaction. Accordingly, a user interface (UI) can be provided for communicating with cloud resources 605 and/or performing tasks associated with cloud resources 605. The UI can be accessed via a client device 610 in communication with cloud resources 605. The UI can be configured to operate in a variety of client modes, including a fat client mode, a thin client mode, or a hybrid client mode, depending on the storage and processing capabilities of cloud resources 605 and/or client device 610. Therefore, a UI can be implemented as a standalone application operating at the client device in some embodiments. In other embodiments, a web browser-based portal can be used to provide the UI. Any other configuration to access cloud resources 605 can also be used in various implementations.

### Mobile Device Application

FIG. 7 is representative of a user interface for a mobile device in accordance with aspects of the present disclosure. In embodiments, user interface 700 is representative of a mobile application that can be uploaded and stored onto a mobile device and/or electric vehicle and/or other computing device of the driving population and owners of charging system. In embodiments, the mobile application provides communication between the adapter 100, the owner of the charging system (which uses adapter 100) and drivers of electric vehicles which are desirous to use the charging system.

In embodiments, the mobile application, through the program applications described above, provide the following functionality/capability:

1. The ability to register and/or sign onto a network that tracks and/or monitors a plurality of charging systems that are available for use by electric vehicles;

2. The ability to search and locate available charging systems that are part of the network;

3. The ability to make a reservation for a certain time and/or date for use of an available charging system within the network, and receive an access code from such charging system upon the acceptance of such reservation;

4. The ability to generate the access code (e.g., unique ID, pin code, etc.) to the charging system and provide such access code to the driver of the electric vehicle;

5. The ability to automatically provide the access code to the adapter when the vehicle is plugged into and detected by the adapter in order to automatically start a charging operation;

6. The ability to monitor electrical usage of the charging system by both the owner and user of the charging system;

7. The ability to automatically charge the user for use of the charging system. This charge may be based on time of day, amount of time using the charging station, amount of electricity used or other metric, e.g., type of user, etc., agreed to in advance of the use of the charging system;

8. The ability to charge a fee when the driver does not show up for a set reservation;

9. The ability to rate the users of the charging system, e.g., a user that is known to damage equipment or a user that does not show up for their reservations, etc., may be rated higher than other users in order to adjust charging fees accordingly;

10. The ability to filter information. This filtered information may be, for example, types of charging systems, locations of charging system, fees charged for using the charging systems, etc.; and

11. The ability to enter a one time code to use the charging system when the driver is not a registered user of the network; and

12. The ability of the owner of the charging system to program adapter 100 to include, for example, different billing rates, messages to the user, safety protocols, etc.

In embodiments, the above-noted functionality/capability can be provided and processed by computing infrastructure shown in FIG. 5 (e.g., though application programs 550) and/or using cloud environment provided in FIG. 6. Moreover, the above-noted functionality/capability can be provided using communication interface 540 as described with respect to FIG. 5. In this way, the electric vehicle or other device of the driver can pass information between the vehicle and the network for processing the tasks noted throughout the present disclosure, including the management, monitoring, safety and financial transactions when the vehicle is detected to be plugged into the charging system, via adapter 100.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. An adapter, comprising:
a housing;
a male connector at a first side of the housing which is structured to plug into an electric device;
a female connector at a second side of the housing which is structured to plug into a charging system; and
a controller which provides management functions to provide an electric charge to the electric device.

2. The adapter of claim 1, further comprising at least one cover that is hinge mounted to the housing and which covers the female connector.

3. The adapter of claim 1, further comprising a user interface on the housing, the user interface comprising a keypad and a display screen.

4. The adapter of claim 1, further comprising a locking mechanism about the female connector.

5. The adapter of claim 4, wherein the locking mechanism comprises:
a female socket inner wall squeeze pad which is designed, structured and configured to accommodate a male plug of the charging system;
a restricting band comprising a plurality of slots and a screw drive which engages with the plurality of slots, and which surrounds the female socket inner wall squeeze pad;
a cylinder hole extending within housing to provide access to the screw drive; and
a locking mechanism to lock the restricting band.

6. The adapter of claim 5, wherein the restricting band is within the housing and the female socket inner wall squeeze pad surrounds comprises flexible material to provide a friction connection to the male plug.

7. The adapter of claim 1, further comprising a communication interface which is configured to communicate with at least one remote device and the electric device through a network.

8. The adapter of claim 7, wherein the communications interface is configured to provide status information of the adapter to the at least one remote device and the electric device.

9. The adapter of claim 1, wherein the controller automatically meters electrical current to the electric device when the electric device is detected to be plugged into the male connector of the adapter.

10. The adapter of claim 1, wherein the controller provides an authentication code to a user of the electric device upon making of a reservation.

11. The adapter of claim 10, wherein the controller provides a handshake protocol to authorize use of the charging system through the adapter.

12. The adapter of claim 1, wherein the controller monitors usage of the charging system.

13. The adapter of claim 1, wherein the controller manages financial transactions for usage of the charging system.

14. An adapter, comprising:
a housing comprising a male connector and a female connector;
a controller which manages electric flow between the male connector and the female connector; and
a communication device that communicates information between the controller and at least one remote device.

15. The adapter of claim 14, wherein the controller monitors usage of the adapter and manages financial transactions for usage of a charging system for an electric vehicle.

16. The adapter of claim 14, wherein the controller meters electrical current to an electric vehicle through the adapter when the electric vehicle is detected to be plugged into the male connector.

17. The adapter of claim 14, further comprising locking mechanism to friction lock the female connector to a male plug of a charging station.

18. The adapter of claim 17, wherein the locking mechanism comprises:
a female socket inner wall squeeze pad comprising flexible material;
a restricting band which surrounds the female socket inner wall squeeze pad;
a cylinder hole extending within housing to provide access to the restricting band e; and
a locking mechanism to lock the restricting band.

19. A system comprising:
a processor, a computer readable memory, one or more computer readable storage media, and program instructions collectively stored on the one or more computer readable storage media, the program instructions executable to:
detect an electric vehicle is plugged into an electric vehicle supply system;
provide an electric charge to the electric vehicle through the electric vehicle supply system when the electric vehicle is detected to be plugged into the electric vehicle supply system;
monitor and manage the electric charge to the electric vehicle; and
provide information associated with the electric charging of the electric vehicle to an owner of the electric vehicle supply system and a driver of the electric vehicle via wireless communication.

20. The system of claim 19, wherein the information includes broadcasting availability of the electric vehicle supply system to potential users, along with allowing the potential users an ability to reserve usage of the electric vehicle supply system.
